(19) United States
(12) Patent Application Publication
(10) Pub. No.: US 2025/0371453 A1
(43) Pub. Date: Dec. 4, 2025

(54) CORPORATE ISSUE MANAGEMENT SERVER AND CORPORATE ISSUE MANAGEMENT METHOD

(71) Applicant: LegalOn Technologies, Inc., Tokyo (JP)

(72) Inventor: Ruka FUNAKI, Tokyo (JP)

(21) Appl. No.: 19/299,323

(22) Filed: Aug. 13, 2025

Related U.S. Application Data
(63) Continuation of application No. PCT/JP2024/004729, filed on Feb. 13, 2024.

(30) Foreign Application Priority Data
Feb. 14, 2023 (JP) 2023-021197
May 8, 2023 (JP) 2023-076945

(51) Int. Cl. G06Q 10/0631; G06Q 10/109

(52) U.S. Cl. CPC G06Q 10/06311; G06Q 10/1097

(57) ABSTRACT

A corporate issue management server according to an embodiment includes at least one processor. The processor generates display information for displaying pieces of information indicating a plurality of corporate issues included in a plurality of pieces of registered corporate issue information based on the corporate issue information including the corporate issue of an organization and information on at least one decision-making body, which makes a decision regarding the corporate issue, of the organization.

### CROSS-REFERENCE TO RELATED APPLICATIONS

This application is a continuation application of International Application No. PCT/JP2024/004729, filed on Feb. 13, 2024, which designates the United States and claims the benefit of priority from Japanese Patent Application No. 2023-021197, filed on Feb. 14, 2023, and Japanese Patent Application No. 2023-076945, filed on May 8, 2023, the entire contents of all of which are incorporated herein by reference.

### FIELD

Embodiments of the present disclosure relate to a corporate issue management server, a corporate issue management method, and a corporate issue management program.

### BACKGROUND

Conventionally, techniques have been proposed to support the operation of an organization. For example, Japanese Laid-Open Patent Application Publication No. 2022-014405 discloses a technique in which item names according to each content with respect to business-related matters including preconditions including a management philosophy and the like, a business plan, and the like, are arranged and displayed, when any one of the arranged item names is selected, an item input display that enables input of the content according to the selection is changed and displayed in response to the selection, and when an input to a specified item specified in advance or an operation of confirming the input out of inputtable content, the display is changed in an identifiable manner with respect to an item name according to the input or the operation among the arranged item names.

### SUMMARY

A corporate issue management server according to an embodiment includes at least one processor. The processor may generate display information for displaying pieces of information indicating a plurality of corporate issues included in a plurality of pieces of registered corporate issue information based on the corporate issue information including the corporate issue of an organization and information on at least one decision-making body, which makes a decision regarding the corporate issue, of the organization.

### BRIEF DESCRIPTION OF DRAWING

FIG. 1 is a schematic diagram for describing an overview of a corporate issue management system according to an embodiment.

FIG. 2 is a block diagram illustrating an example of a hardware configuration of a corporate issue management server according to the embodiment.

FIG. 3 is a block diagram illustrating an example of a functional configuration of the corporate issue management server according to the embodiment.

FIG. 4 is a block diagram illustrating an example of a hardware configuration of a terminal device according to the embodiment.

FIG. 5 is a block diagram illustrating an example of a functional configuration of the terminal device according to the embodiment.

FIG. 6 is a flowchart illustrating an example of a procedure of corporate issue management regarding a corporate issue that requires a resolution by a decision-making body having a bureau according to the embodiment.

FIG. 7 is a flowchart illustrating an example of a flow of corporate issue management processing according to the embodiment.

FIG. 8 is a view illustrating an example of a notification information screen displayed on a display of the terminal device in the corporate issue management processing according to the embodiment.

FIG. 9 is a view illustrating an example of a corporate issue list display screen displayed on the display of the terminal device in the corporate issue management processing according to the embodiment.

FIG. 10 is a view illustrating an example of a progress display screen displayed on the display of the terminal device in the corporate issue management processing according to the embodiment.

FIG. 11 is a view illustrating an example of a corporate issue detail display screen displayed on the display of the terminal device in the corporate issue management processing according to the embodiment.

FIG. 12 is a view illustrating an example of a meeting management screen displayed on the display of the terminal device in the corporate issue management processing according to the embodiment.

FIG. 13 is a view illustrating an example of a meeting detail display screen displayed on the display of the terminal device in the corporate issue management processing according to the embodiment.

FIG. 14 is a view illustrating an example of a minute display screen displayed on the display of the terminal device in the corporate issue management processing according to the embodiment.

FIG. 15 is a diagram illustrating an example of an overview of the corporate issue management system according to the embodiment and an external information processing system.

FIG. 16 is a view illustrating an example of an agenda item generation screen displayed on the display of the terminal device in the corporate issue management processing according to the embodiment.

### DESCRIPTION

However, for the purpose of supporting the operation of an organization, there is room for improvement.

An embodiment of the present disclosure has been made in view of the above circumstances, is to support management of corporate issues in organizations.

Hereinafter, an embodiment of a corporate issue management system, a corporate issue management server, a terminal device, an information processing system, a management system, a corporate issue management method, a corporate issue management program, and a storage medium according to the present disclosure will be described in detail with reference to the drawings. In the following description, components having substantially the same functions and configurations may be denoted by the same reference signs, and redundant description will be made if necessary. In addition, the embodiment can be appropriately combined with other embodiments, modifications, and/or conventional techniques.

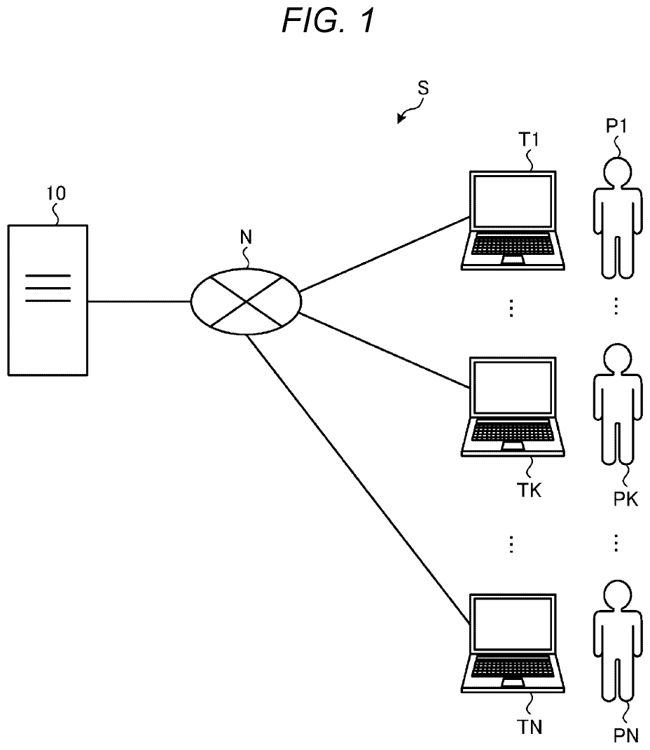

FIG. 1 is a schematic diagram for describing an overview of a corporate issue management (CIM) system S according to the present embodiment. The corporate issue management system S according to the embodiment is a system that provides a corporate issue management service that supports management of corporate issues in operation and management of various organizations including companies. Note that a part or a whole of the corporate issue management system S may be simply referred to as a system in the present disclosure.

A corporate issue in the present disclosure may be, for example, a topic for which decision-making is performed by a decision-making body of an organization, and include at least one agenda item. Here, examples of the decision-making body of the organization may include meeting bodies such as a meeting of the board of directors, a management meeting, a meeting of operating officers, a business division meeting, a division managers' meeting, and a section chiefs' meeting. The decision-making body may be an institution or a meeting body defined by laws related to organizations such as the Companies Act, or may be defined internally. The meeting body may have a bureau engaged in the meeting body.

The decision-making body may operate the organization by making a decision based on, for example, the corporate issue. As an example, the decision-making body may make various decisions such as introducing a benefit program to increase the satisfaction level of employees, receiving a loan to stabilize cash flow, and setting a policy of focusing more on patents and filing applications.

As illustrated in FIG. 1, the corporate issue management system S of the present embodiment may include a corporate issue management server 10 and at least one terminal device T1 to TN. In the corporate issue management system S, the corporate issue management server 10 and each of the at least one terminal devices T1 to TN may be configured to be able to communicate with each other via a network N.

The at least one terminal device T1 to TN of the present embodiment may be operated by users P1 to PN, respectively. Note that, in the following description, the terminal device T1 operated by the user P1 will be described as an example when the at least one terminal devices T1 to TN are not distinguished. In addition, the terminal devices T1 to IN may be collectively referred to as a terminal device T when the at least one terminal devices T1 to TN are not distinguished. Similarly, the users P1 to PN may be collectively referred to as a user P when the users P1 to PN are not distinguished.

The terminal device T1 may be operated by, for example, the user P1 who is a member of an organization. The user P1 may consider an agenda item, propose the agenda item to a decision-making body of the organization, reconsider the agenda item in response to a result (resolution) of discussion of the decision-making body, and execute business in accordance with the resolution.

The terminal device TK may be operated by, for example, the user PK who is a member of a bureau of a meeting body (the decision-making body) of the organization. The user PK may support decision making by the decision-making body by sending a convocation notice to a meeting to discuss the proposed agenda item.

The terminal device TN may be operated by, for example, the user PN who is a member of the decision-making body of the organization. The user PN may confirm information regarding a meeting scheduled to participate, such as a convocation notice and materials, the status of each corporate issue, and make a decision.

Next, specific configurations of the corporate issue management server 10 and the terminal device T1 of the embodiment will be described.

### (Corporate Issue Management Server 10)

The corporate issue management server 10 of the present embodiment may be, for example, a device that is connected to a client device by communication and performs various types of processing in response to a request from the client device. The corporate issue management server 10 may be, for example, a server device managed by a vendor that provides a corporate issue management service. The corporate issue management server 10 may provide the corporate issue management service to the terminal device T1 in response to a result of input or an operation regarding the corporate issue received from the terminal device T1, which is the client device, via the network N.

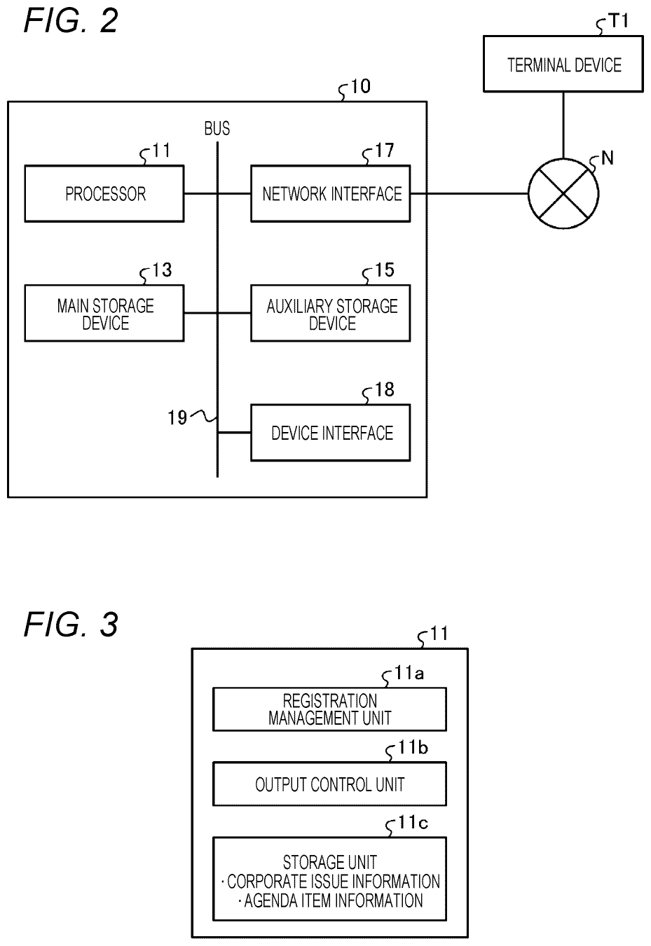

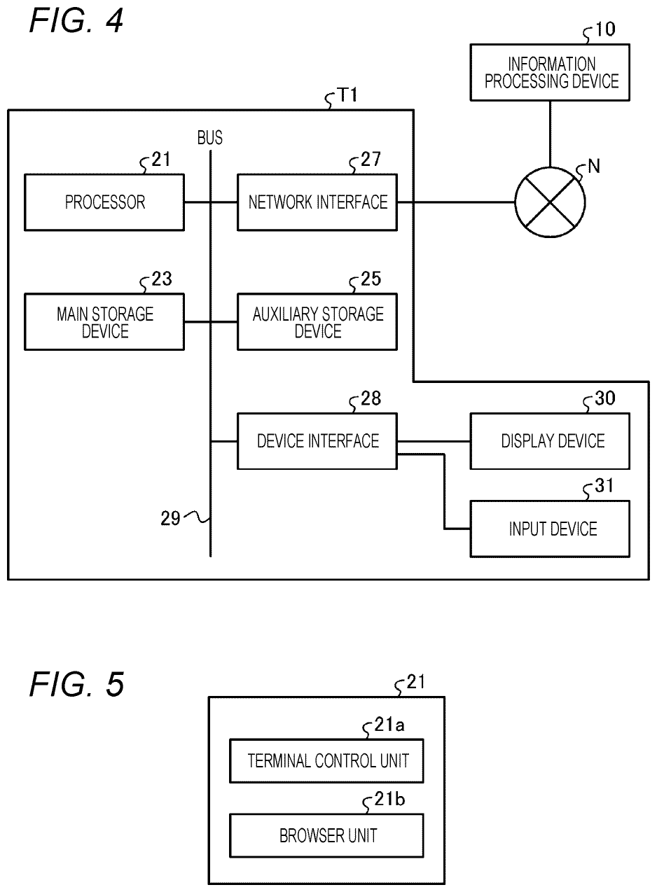

FIG. 2 is a block diagram illustrating an example of a hardware configuration of the corporate issue management server 10 according to the embodiment. For example, as illustrated in FIG. 2, the corporate issue management server 10 may have a configuration similar to that of a general computer, and include, for example, a processor 11, a main storage device (memory) 13, an auxiliary storage device (memory) 15, a network interface 17, and a device interface 18. The processor 11, the main storage device 13, the auxiliary storage device 15, the network interface 17, and the device interface 18 are connected to be capable of communicating with each other via, for example, a bus 19. The corporate issue management server 10 is shown as an information processing devise 10 in FIG. 4.

Note that FIG. 2 illustrates the corporate issue management server 10 having each one of components, but the embodiment of the present disclosure is not limited thereto. The corporate issue management server 10 may have a plurality of the same components. In addition, one corporate issue management server 10 is illustrated in FIG. 2, but software may be installed in a plurality of computers, and each of the plurality of computers may execute the same or different parts of processing of the software. In this case, there may be a form of distributed computing in which each of the plurality of computers communicates via the network interface 17 or the like to execute processing. That is, the corporate issue management server 10 according to the embodiment may be configured as a system that implements various functions to be described later by one or a plurality of computers executing commands stored in one or a plurality of storage devices.

Various calculations of the corporate issue management server 10 may be executed in parallel processing using one or a plurality of processors or using a plurality of computers via a network. In addition, various computations may be distributed to a plurality of computing cores in the processor and executed in parallel processing. In addition, some or all of the processing, means, and the like of the present disclosure may be executed by at least one of a processor and a storage device provided on a cloud that can communicate with the corporate issue management server 10 via the network N. As described above, the processing of the corporate issue management system S in the present embodiment may be in a form of parallel computing by one or a plurality of computers.

The processor 11 may be an electronic circuit (a processing circuit, a processing circuitry, a central processing unit (CPU), a graphics processing unit (GPU), a field programmable gate array (FPGA), an application specific integrated circuit (ASIC), or the like) including a control device and a computing device of the corporate issue management server 10. In addition, the processor 11 may be a semiconductor device or the like including a dedicated processing circuit. The processor 11 may be achieved by an optical circuit using an optical logic element without being limited to an electronic circuit using an electronic logic element. In addition, the processor 11 may include a computing function based on quantum computing.

The processor 11 can perform computational processing based on data and software (program) input from each device or the like of the internal configuration of the corporate issue management server 10, and output a computation result and a control signal to each device or the like. The processor 11 may control each component constituting the corporate issue management server 10 by executing an operating system (OS), an application, or the like of the corporate issue management server 10.

The corporate issue management server 10 in the present embodiment may be achieved by one or a plurality of processors 11. Here, the processor 11 may refer to one or a plurality of electronic circuits disposed on one chip, or may refer to one or a plurality of electronic circuits disposed on two or more chips or two or more devices. When the plurality of electronic circuits are used, the electronic circuits may communicate in a wired or wireless manner.

The main storage device 13 may be a storage device that stores commands executed by the processor 11, various types of data, and the like, and information stored in the main storage device 13 may be read by the processor 11. The auxiliary storage device 15 may be a storage device other than the main storage device 13. Note that each of these storage devices may mean any electronic component capable of storing electronic information, and may be a semiconductor memory. The semiconductor memory may be either a volatile memory or a nonvolatile memory. A storage device for storing various types of data used in the corporate issue management server 10 according to the embodiment may be achieved by the main storage device 13 or the auxiliary storage device 15, or may be achieved by a built-in memory built in the processor 11. For example, the storage unit in the embodiment may be achieved by the main storage device 13 or the auxiliary storage device 15.

To one storage device (memory), a plurality of processors may be connected (coupled), or the single processor 11 may be connected. A plurality of storage devices (memories) may be connected (coupled) to one processor. When the corporate issue management server 10 according to the embodiment includes at least one storage device (memory) and a plurality of processors connected (coupled) to the at least one storage device (memory), at least one processor among the plurality of processors may be connected (coupled) to the at least one storage device (memory). In addition, this configuration may be achieved by a storage device (memory) included in a plurality of computers and the processor 11. Furthermore, a storage device (memory) may be integrated with the processor 11 (for example, a cache memory including an L1 cache and an L2 cache).

The network interface 17 may be an interface for connecting to the network N in a wireless or by wired manner. As the network interface 17, an appropriate interface such as one conforming to an existing communication standard may be used. The network interface 17 may exchange information with an external device connected via the network N. Note that the network N may be any of a wide area network (WAN), a local area network (LAN), a personal area network (PAN), and the like, or may be a combination thereof, and may be one that allows exchange of information between the corporate issue management server 10 and the external device. Examples of the WAN include the Internet, examples of the LAN include IEEE802.11 and Ethernet (registered trademark), and examples of the PAN include Bluetooth (registered trademark) and near field communication (NFC).

The device interface 18 may be an interface such as a universal serial bus (USB) directly connected to an output device such as a display device, an input device, and an external device. In addition, the external device may be a storage device (memory), a network storage, a storage such as an HDD, or the like. In addition, the external device may be a device having some functions of components of the corporate issue management server 10 according to the embodiment. That is, the corporate issue management server 10 may transmit or receive a part or all of a processing result of the external device.

FIG. 3 is a block diagram illustrating an example of a functional configuration of the corporate issue management server 10 according to the embodiment. For example, as illustrated in FIG. 3, the corporate issue management server 10 may have functions as a registration management unit 11a, an output control unit 11b, and a storage unit 11c. Specifically, at least one program for implementing the respective functions of the corporate issue management server 10 may be stored in, for example, the main storage device 13 or the auxiliary storage device 15. The processor 11 can implement the respective functions of the corporate issue management server 10 by reading and executing the program stored in the main storage device 13, the auxiliary storage device 15, or the like.

The registration management unit 11a may perform information communication with the terminal device T1 via the network, for example. Specifically, the registration management unit 11a may receive input of information regarding a corporate issue from the terminal device T1. In addition, the registration management unit 11a may store the received information regarding the corporate issue in the storage unit 119.

The output control unit 11b may perform, for example, information communication with the terminal device T1 via the network. Specifically, the output control unit 11b may generate display information for displaying information regarding a corporate issue, and output the display information to the terminal device T1. Note that each piece of the display information may include layout information. As an example, the output control unit 11b may generate display information for displaying information indicating a plurality of registered corporate issues, and output the display information to the terminal device T1.

The storage unit 11c may store various programs executed in the corporate issue management server 10. In addition, the storage unit 11c may store information regarding a corporate issue. Note that the information regarding the corporate issue may include document data or voice data uploaded from the terminal device T1.

### (Terminal Device T1)

The terminal device T1 of the present embodiment may transmit and receive information regarding a corporate issue to and from the corporate issue management server 10 in the corporate issue management service.

FIG. 4 is a block diagram illustrating an example of a hardware configuration of the terminal device T1 according to the embodiment. As illustrated in FIG. 4, the terminal device T1 of the present embodiment may have a configuration similar to that of a general computer, and includes, as an example, a processor 21, a main storage device (memory) 23, an auxiliary storage device (memory) 25, a network interface 27, a device interface 28, a display device 30, and an input device 31. The processor 21, the main storage device 23, the auxiliary storage device 25, the network interface 27, and the device interface 28 may be connected to be capable of communicating with each other via, for example, a bus 29. The display device 30 and the input device 31 may be connected to the device interface 28.

The processor 21, the main storage device 23, the auxiliary storage device 25, the network interface 27, and the device interface 28 may have hardware configurations similar to those of the processor 11, the main storage device 13, the auxiliary storage device 15, the network interface 17, and the device interface 18, respectively, and the description thereof will be omitted.

The display device 30 may be, for example, a display device such as a liquid crystal display (LCD), a cathode ray tube (CRT), a plasma display panel (PDP), or an organic electro luminescence (EL) panel. Based on an instruction from the processor 21, the display device 30 may display, for example, each screen for displaying information regarding a corporate issue to be described later.

The input device 31 may be, for example, a device such as a keyboard, a mouse, or a touch panel. The input device 31 may receive various operation inputs by the user P1, for example, in corporate issue management processing to be described later. The input device 31 may output a result of the operation input received from the user P1 to the processor 21.

Note that other external devices such as a camera, a microphone, motion capture, and various sensors may be connected to the terminal device T1 via the device interface 18.

FIG. 5 is a block diagram illustrating an example of a functional configuration of the terminal device T1 according to the embodiment. As illustrated in FIG. 5, the terminal device T1 of the present embodiment may have functions as a terminal control unit 21a and a browser unit 21b. Specifically, at least one program for implementing the respective functions of the terminal device T1 is stored in, for example, the main storage device 23 or the auxiliary storage device 25. The processor 21 can implement the respective functions of the terminal device T1 by reading and executing the program stored in the main storage device 23, the auxiliary storage device 25, or the like.

For example, the terminal control unit 21a may activate the browser unit 21b in response to an instruction from the user.

The browser unit 21b may be, for example, a general web browser, and execute processing according to hyper text markup language (HTML) data, a script (for example, Java (registered trademark) Script), or the like. When being activated, the browser unit 21b may transmit an initial access URL to the corporate issue management server 10 to make access.

For example, the browser unit 21b may display data including text data and image data received from the corporate issue management server 10 on the display device 30 of the terminal device T1 in a predetermined form. More specifically, in the corporate issue management processing, the browser unit 21b may display information regarding a corporate issue on the display device 30 of the terminal device T1 in a predetermined form based on display information received from the corporate issue management server 10.

### (Procedure of Corporate Issue Management)

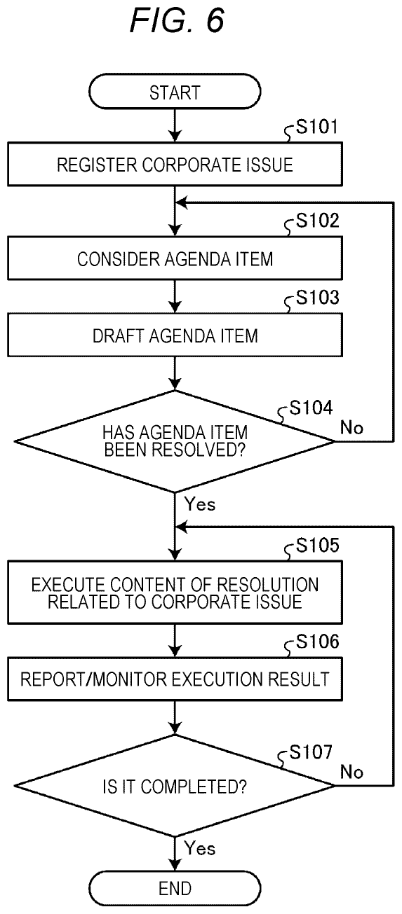

Next, management of a life cycle of a corporate issue performed by utilizing the corporate issue management service provided by the corporate issue management system S according to the embodiment will be described. FIG. 6 is a flowchart illustrating an example of a procedure of corporate issue management regarding a corporate issue that requires a resolution by the decision-making body having the bureau according to the embodiment.

First, for example, the user P1 who is the member of the organization may register a corporate issue in the corporate issue management system S by inputting information regarding the corporate issue using the terminal device T1 (S101). Note that the registration of information regarding the corporate issue may be performed by the user PK of the bureau or the user PN of the decision-making body.

Then, for example, the user P1 may register or consider an agenda item included in the registered corporate issue (S102), then draft the considered agenda item, and propose the drafted agenda item to the decision-making body (S103).

The user PK of the bureau of the decision-making body may manage a meeting for the decision-making body to discuss the agenda item. In addition, the user PN of the decision-making body may make a decision (resolution) on the agenda item proposed at the meeting as the member of the decision-making body. In addition, when the decision may be made by the decision-making body, the user PK of the bureau may register the content of the meeting, such as a discussion and a conclusion (content of the resolution) by the decision-making body, in the corporate issue management system S.

As a result of the resolution of the decision-making body on the proposed agenda item, in a case where reconsideration such as return is decided or there is an unresolved agenda item (S104: No), the user P1 may perform consideration (S102) and proposal (S103) again while referring to the registered content of the meeting of the decision-making body.

On the other hand, in a case where the proposed agenda item has been resolved by the decision-making body (S104: Yes), for example, the user P1 may execute the content of the resolution by the decision-making body (S105) and register an execution result in the corporate issue management system S to report the execution result to the decision-making body. In addition, for example, the user PN may monitor the corporate issue by referring to the registered execution result (S106). Thereafter, until a countermeasure for the corporate issue is completed (S107: Yes), proposal of an agenda item that is new or needs to be reconsidered, execution of content of a resolution (S105), and reporting (S106) are repeated (S107: No).

### (Flow of Corporate Issue Management Processing)

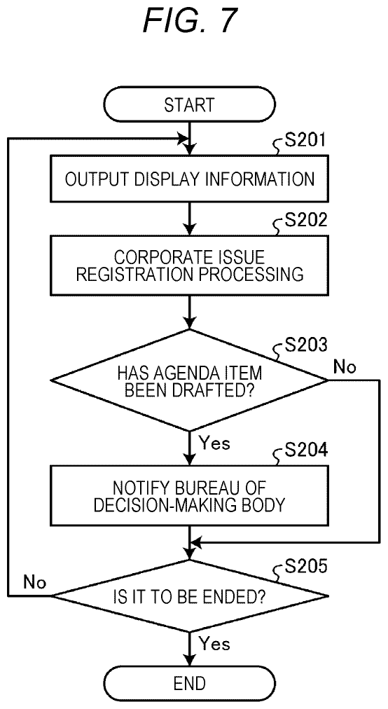

Next, an example of the corporate issue management processing implemented by the corporate issue management server 10 according to the embodiment will be described. FIG. 7 is a flowchart illustrating an example of a flow of corporate issue management processing according to the present embodiment.

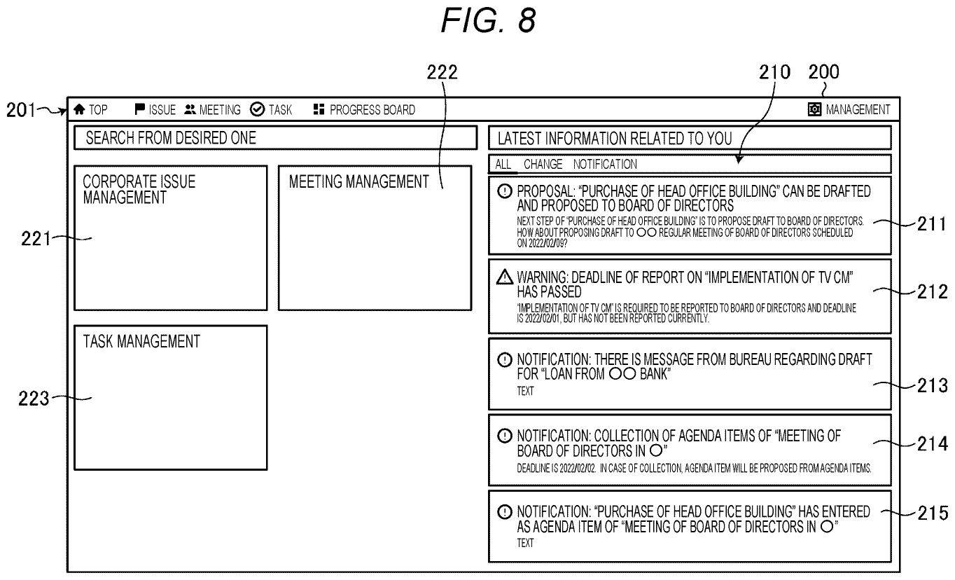

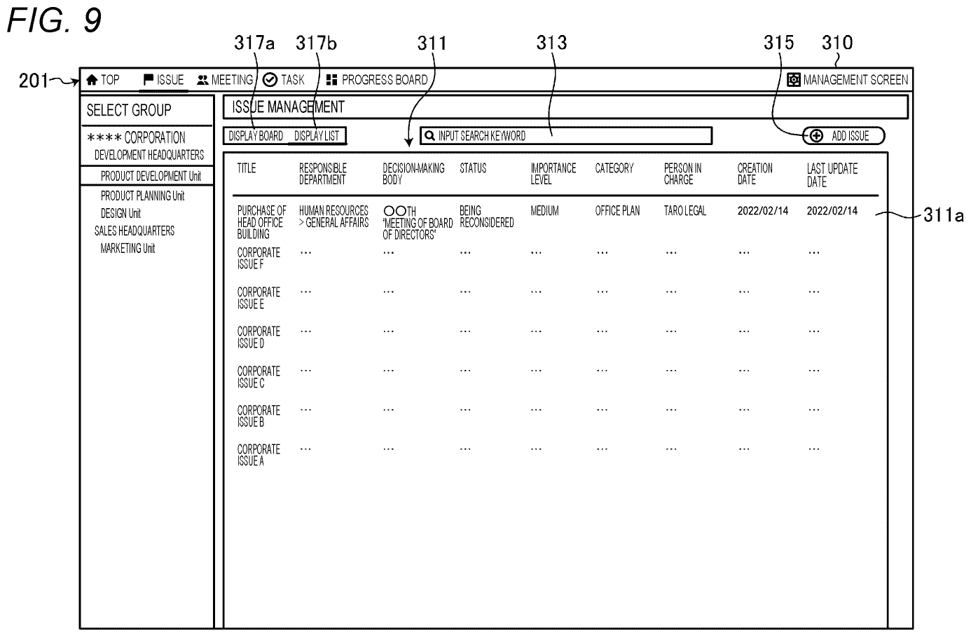

For example, the output control unit 11b may output display information to the terminal device T in response to access from the terminal device T using an initial access URL (S201). For example, in a case where the display information is displayed immediately after a user accesses the system, it is preferable that the display information includes a display that allows the functions of the entire system to be viewed together as illustrated in FIG. 8 and information managed by the system related to the user. Note that this display information may be information for displaying a screen at the time of previous log-out, such as screens illustrated in FIGS. 9 to 14, and can be set as appropriate.

The registration management unit 11a may execute corporate issue registration processing based on, for example, an output in response to a user operation from the terminal device T (S202).

For example, in a case where an agenda item has been proposed in the corporate issue registration processing or the corporate issue management processing (see FIGS. 9 to 11) (S203: Yes), the registration management unit 11a can further generate notification information for notifying the user PK of the bureau of the decision-making body set for the item of the proposal of the agenda item (S204). The notification information may be displayed on the notification screen (see FIG. 8), for example, when the user PK may access the corporate issue management server 10 from the terminal device TK through the web browser. In addition, for example, the notification may be a notification transmitted to the outside of the system, such as an email or an external chat tool.

In addition, for example, the registration management unit 11a may determine whether to end the corporate issue management processing (S205). For example, in a case where a user operation of closing the web browser or a user operation of logging out of the corporate issue management service is performed in the terminal device T, it may be determined to end the corporate issue management processing. In a case where it is not determined to end the corporate issue management processing (S205: No), for example, the processing may return to S201 to output the display information to the terminal device T. On the other hand, in a case where it is determined to end the corporate issue management processing (S205: Yes), the processing may end.

Note that the registration management unit 11a may determine not to end the corporate issue management processing, for example, in a case where a user operation is performed on “Top” of a navigation bar 201 in each screen.

FIGS. 8 to 14 are views illustrating examples of screens displayed as web browser screens on at least one display device 30 of the terminal device T in the corporate issue management processing according to the embodiment. Note that, when the initial access URL is transmitted from the terminal device T, the corporate issue management server 10 may authenticate the user connected to the system by, for example, causing the user to log in using an ID, a password, and the like if necessary. In a configuration for performing the user authentication, the output control unit 11b may output, for example, display information for displaying a screen for input of login information such as an ID and a password to the terminal device T in response to the access from the terminal device T using the initial access URL. Each of the screens illustrated in FIGS. 8 to 14 can be a screen transitioned from the screen for the input of login information.

FIG. 8 illustrates an example of a screen (notification information screen 200) including notification information. As illustrated on the right side of FIG. 8, the notification information screen 200 may include a display area 210 of notification information for presenting notification information regarding a corporate issue related to the user P accessing from the terminal device T, for example, as “Latest information related to you”. It is preferable that the notification information screen 200 is displayed immediately after the system is accessed in order to reduce the user who has made access from overlooking the screen. As described above, the corporate issue management system S according to the embodiment may be equipped with a reminder function including a meeting document submission deadline or a notification function. FIG. 8 illustrates pieces of notification information 211 to 215 regarding corporate issues related to the user P accessing from the terminal device T.

The notification information may include information generated by the system in order to facilitate corporate issue management and holding of a meeting, such as a recommendation of content of a proposal and/or a proposal timing of an agenda item, a report of an execution result of content of a resolution, and status management of an agenda item, which relate to the user P, or information generated by another user.

For example, regarding a proposal of an agenda item, the notification information 211 is an example of a notification for proposing a preferable time for the proposal to the user P in consideration of the content of the proposal, a decision-making body to which the proposal is to be made, and a meeting schedule of the decision-making body. The notification information 212 is an example of an alert notification that urges the user P to report an execution result of content of a resolution regarding a corporate issue that is an agenda item that has been approved by the board of directors regarding implementation of TV CM and is required to be reported to the board of directors but has not been reported currently although a reporting deadline has passed. The notification information 213 is an example of a notification for notifying the user P of a discussion in text or reception of a message from another user (the user PK of the bureau in the case of this notification) regarding a corporate issue, such as “Notification: there is message from bureau regarding proposal for “Loan from ABC bank”. The notification information 214 is an example of a notification for notifying a schedule related to corporate issue management and/or holding of a meeting, such as “Notification: Collection of agenda items of “meeting of board of directors in this month” has started. The deadline is 2022/02/02. In case of the collection, an agenda item will be proposed from agenda items”. The notification information 215 is an example of a notification for notifying the status and progress of a corporate issue related to the user P such as “Notification: “Purchase of head office building” has entered as agenda item of “Meeting of board of directors in this month”.

Note that it is preferable that notification information with respect to the user PK of the bureau that manages a meeting of the decision-making body includes a notification for notifying that an agenda item has been proposed to the meeting. In addition, it is preferable that notification information with respect to the user PN belonging to the decision-making body includes a convocation notice to the meeting for discussing the agenda item and making a decision. In addition, it is preferable that a type and content of the notification information to be notified can be changed according to a role of the user and settings.

As described above, by generating and transmitting various notifications, the corporate issue management system S according to the embodiment can recommend or remind a response of the user P regarding corporate issue management in which the user P is registered, notify the status or progress of a corporate issue or an agenda item, or encourage a discussion, and can support the management of the corporate issue in the organization.

In addition to the notification information, the notification information screen 200 in FIG. 8 may include a button 221 for instructing to proceed to “Corporate issue management”, a button 222 for instructing to proceed to “Meeting management”, and a button 223 for instructing to proceed to “Task management”. As described above, since the display that allows the functions of the entire system to be viewed together is performed, the convenience of the system may be enhanced.

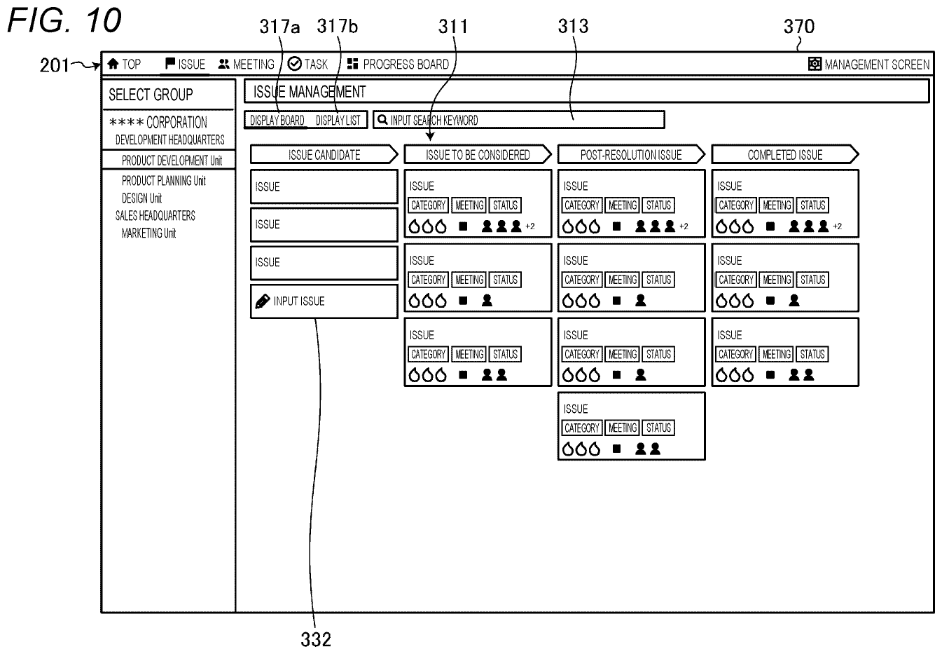

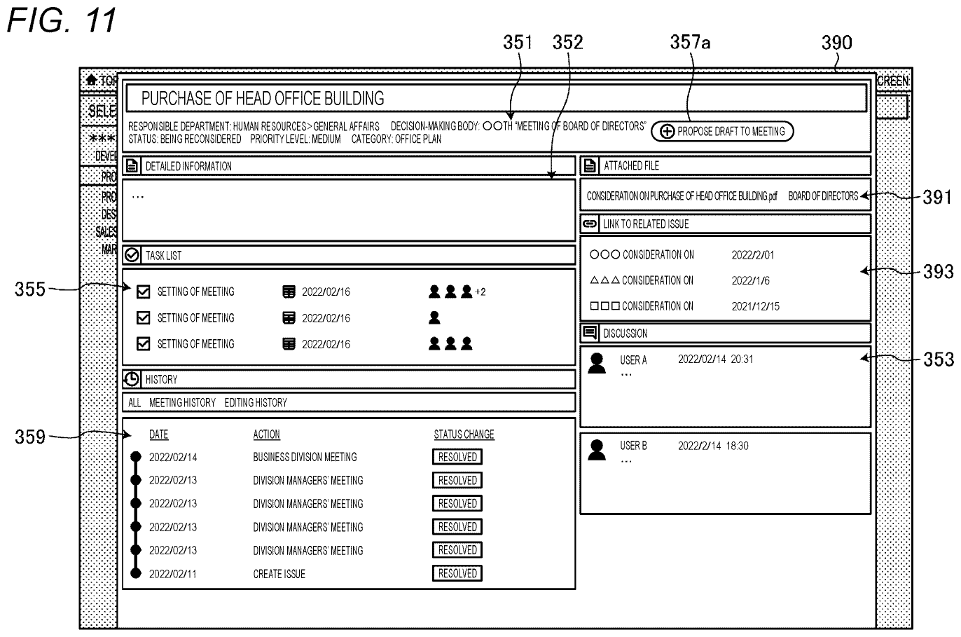

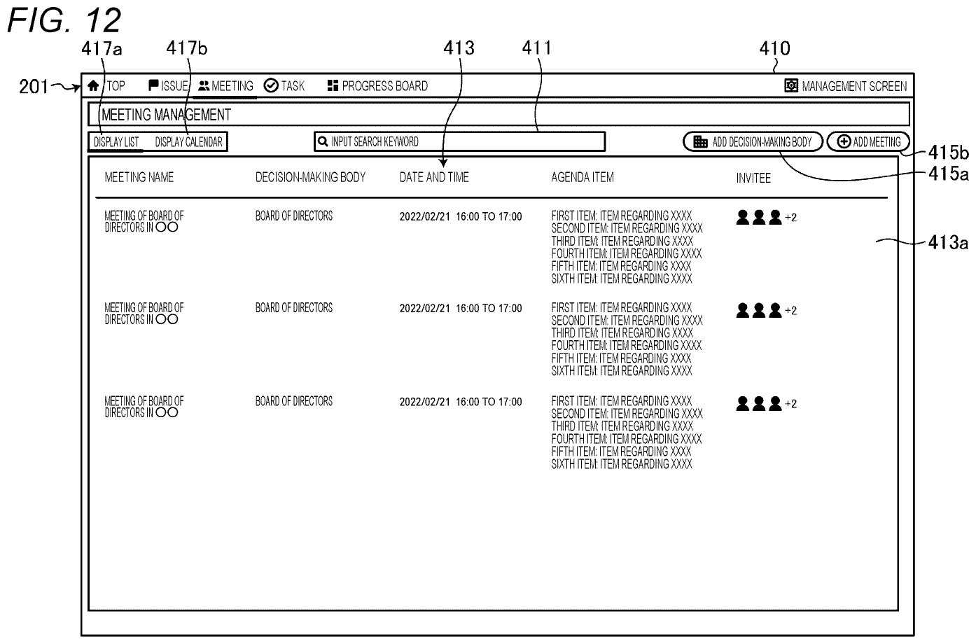

Note that a display mode of the terminal device T may be changed, for example, in response to a user operation. For example, in a case where “Top” on the navigation bar 201 is operated in the example of FIG. 8, the output control unit 11b may cause a transition to the notification information screen 200 in FIG. 8 which is a top screen of the system. In addition, for example, in a case where a display of “Issue” is operated, the output control unit 11b may cause a transition to a corporate issue list display screen 310 in FIG. 9 to handle information on corporate issues. For example, in a case where a display of “Meeting” is operated, the output control unit 11b may cause a transition to a meeting management screen 410 in FIG. 12 to handle information on meetings. For example, in a case where a display of “Task” is operated, the output control unit 11b may cause a transition to the same screen as that in a case where the button 223 for instructing to proceed to “Task management” is operated. In addition, for example, in a case where “Progress board” is operated, the output control unit 11b may cause a transition to a progress display screen 370 in FIG. 10 in which current states of various tasks are displayed in a list. Note that, in the present specification, a button is an example of an area operated by the user for a predetermined purpose, and may be an image such as an icon, a display of text, or another display. Note that, in the present disclosure, a screen transition or a transition is an example of displaying pieces of different information on a screen. Therefore, when pieces of different information are displayed, the display is not limited to the screen transition, and may be performed by a method in which a new screen is displayed on a previous screen such that a plurality of screens overlap each other as illustrated in FIG. 11, a method in which another window is opened for the display, or the like.

FIG. 9 is an example of the corporate issue list display screen 310 as a corporate issue information screen displaying information indicating a plurality of corporate issues registered in the corporate issue management system S. As illustrated in FIG. 9, the corporate issue list display screen 310 may include a corporate issue list display area 311 to display a list of the plurality of corporate issues registered in the corporate issue management system S. The corporate issue list display area 311 may include, for example, display of a title of a corporate issue, a responsible department, a related decision-making body, status, an importance level, a category, a person in charge, a creation date, and a last update date.

Here, the title, the responsible department, the related decision-making body, the status, the importance level, the category, the person in charge, the creation date, and the last update date regarding the corporate issue are examples of corporate issue information. In addition, information including at least the title in the corporate issue information is an example of information indicating each of the plurality of corporate issues. In addition, the category is an example of attribute information indicating an attribute of the corporate issue. Note that a plurality of values may be set for one corporate issue in the corporate issue information such as the category, a related meeting, and the person in charge. In addition, the status is an example of a current state and a conclusion of decision making regarding the corporate issue.

FIG. 9 exemplifies corporate issues A to F and purchase of a head office building as the plurality of corporate issues. For example, the first line in FIG. 9 may indicate that a title of the corporate issue is “Purchase of head office building”, a responsible department of the corporate issue is “Human resources and general affairs”, and the display 311a of the corporate issue indicates that a decision-making body that resolves the corporate issue is “Board of directors”. For example, the display 311a of the corporate issue may indicate that status of the corporate issue is in a state of “Being reconsidered”, an importance level of the corporate issue is “Medium”, a category of the corporate issue is “Office plan”, a person in charge of the corporate issue, that is, the user P1 is “Taro Legal”, and a creation date and a last update date of the corporate issue are “2022/02/14”.

An internal organization such as the responsible department may be set with a hierarchy, for example. For example, the example of FIG. 9 indicates that the general affairs section in the HR department is in charge. This hierarchy may be set in advance as a master or the like.

As described above, the corporate issue management system S according to the embodiment can generate display information that displays, for example, a list of pieces of information indicating a plurality of corporate issues included in a plurality of pieces of registered corporate issue information. Then, the display information from the corporate issue management server 10 can be displayed to the user P through the corporate issue list display screen 310 on the terminal device T. As a result, the user P can easily grasp the corporate issues related to the registered user. Note that, on the corporate issue list display screen 310, all the corporate issues may be displayed, and only some of the corporate issues can be displayed by being narrowed down by the corporate issue information, a keyword to be described later, or the like. In addition, a “list” in the present embodiment may be displaying all items on one page, and include display over a plurality of pages. Note that grasping of the corporate issues achieved by the corporate issue management according to the present embodiment can include a concept of grasping a total amount of a plurality of corporate issues related to the user.

In addition, the corporate issue list display screen 310 may include a display of an input field 313 for input of a search keyword. For example, the output control unit 11b can narrow down corporate issues to be displayed in a list based on the search keyword input by the user P and the plurality of pieces of registered corporate issue information. As a result, the user P can easily confirm the total amount of corporate issues registered, discussed, and resolved in the past while maintaining the browsability, and easily access a desired corporate issue.

In addition, the corporate issue list display screen 310 may include displays of a button 317a for giving an instruction of “Display board” and a button 317b for giving an instruction of “Display list”. For example, in a case where the display of the button 317a for giving an instruction of “Display board” is operated, the output control unit 11b may cause the screen display on the terminal device T to transition from the corporate issue list display screen 310 in FIG. 9 to the progress display screen 370 in FIG. 10.

In addition, for example, in a case where a display of any corporate issue among the plurality of corporate issues displayed in a list in the corporate issue list display area 311 is operated, the output control unit 11b may cause the screen display on the terminal device T to transition from the corporate issue list display screen 310 in FIG. 9 to a corporate issue detail display screen 390 in FIG. 11.

FIG. 10 exemplifies the progress display screen 370 that displays pieces of information indicating a plurality of corporate issues registered in the corporate issue management system S. The progress display screen 370 is an example of a screen that displays pieces of the information indicating the plurality of corporate issues registered in the corporate issue management system S in a display mode different from that of the corporate issue list display screen 310 in FIG. 9.

As illustrated in FIG. 10, the progress display screen 370 may include the corporate issue list display area 311 in which the plurality of corporate issues registered in the corporate issue management system S are displayed in boards separately from current states, and in the present embodiment, one corporate issue is disposed at a corresponding current state position as one card-type display. The corporate issue list display area 311 may includes, for example, displays of stages (types of current states or progress of corporate issues) of a registered issue candidate, an issue to be considered, a post-resolution issue, and a completed issue. For example, each of the plurality of corporate issues is classified into a plurality of stages according to the status of the corporate issue and displayed. In addition, the user can move a displayed portion of the corporate issue between the current states by an operation such as drag and drop. As described above, it is preferable that the corporate issue management system S according to the embodiment is capable of displaying the plurality of corporate issues in one or more different displays. As a result, the corporate issues can be appropriately managed.

In the example of FIG. 10, the corporate issues may displayed for each stage, but the same display may be performed for each status. For example, it is possible to perform display in a classified manner based on status indicating a relationship between a corporate issue and a decision-making body, such as being in middle of creation of a proposal sentence by a user, waiting for a proposal for a meeting, waiting for deliberation at a meeting, being deliberated in writing, being reconsidered, a progress report period, completed, or the like. As a result, it is possible to appropriately manage the progress regarding the corporate issues.

In addition, the progress display screen 370 of FIG. 10 may include the display of the input field 313 for input of a search keyword. For example, the output control unit 11b can narrow down corporate issues to be displayed in a board based on the search keyword input by the user P and the plurality of pieces of registered corporate issue information. As a result, the user P can easily confirm the current state of each of the corporate issues while maintaining the browsability regarding the corporate issues registered, discussed, and resolved in the past, and easily access a desired corporate issue.

In addition, the progress display screen 370 may include a display of a button 332 for giving an instruction of “Input issue”. For example, in a case where the display of the button 332 is operated, the output control unit 11b may cause the screen display on the terminal device T to transition from the progress display screen 370 in FIG. 10 to an issue registration screen for display.

In addition, for example, in a case where the display of the button 317a for giving an instruction of “Display list” is operated, the output control unit 11b may cause the screen display on the terminal device T to transition from the progress display screen 370 in FIG. 10 to the corporate issue list display screen 310 in FIG. 9 for display.

In addition, for example, in a case where a display of any corporate issue among the plurality of corporate issues displayed in the corporate issue list display area 311 is operated, the output control unit 11b may cause the screen display on the terminal device T to transition from the progress display screen 370 in FIG. 10 to the corporate issue detail display screen 390 in FIG. 11.

FIG. 11 illustrates the corporate issue detail display screen 390 that displays any corporate issue selected by the user P among the plurality of corporate issues registered in the corporate issue management system S. Here, the description will be continued using, as an example, a case where the display 311a of the corporate issue having the title “Purchase of head office building” is operated on the corporate issue list display screen 310, the progress display screen 370, or the issue registration screen.

For example, as illustrated in FIG. 11, the corporate issue detail display screen 390 may include a display area 351 of corporate issue information, a display area 352 of detailed information, a display area 353 of a discussion in text, a display area 355 of a task list, and a display area 359 of a history.

Detailed content of a corporate issue may be described in the display area 352 of the detailed information.

The display area 353 of the discussion may include, for example, a display of a comment input field 353a regarding a corporate issue or an agenda item to be registered or updated. For example, the registration management unit 11a may receive input of text from a discussion input field on an issue detail registration screen, any input tool such as an email or a chat tool, or the like, thereby receiving a discussion in text regarding the corporate issue or the agenda item. In the display area 353 of the discussion, for example, the discussion in text input on the issue detail registration screen or the like at the time of registration or update of the corporate issue is displayed. This discussion in text may be, for example, a discussion such as pre-deliberation that is often carried out before a meeting or deliberation on the agenda item. As a result, the user P1 can discuss, deliberate, and communicate with another user P, the user PK of the bureau, and the like by text in advance of the meeting of the decision-making body. In addition, reporting to the user PN of the decision-making body and resolution and approval by the user PN can be easily performed. The display area 353 of the discussion is an example of an area in which information indicating at least one discussion process regarding the corporate issue or the agenda item is displayed.

The display area 355 of the task list may display, for example, a list of tasks related to the corporate issue to be registered or updated. For example, the registration management unit 11a may receive input of a task from a task input field to register the task generated in a discussion regarding the corporate issue or the agenda item. As a result, the user P can input and manage the task generated in relation to the discussion.

The display area 359 of the history may be, for example, an area for displaying a history of registration, updating, and editing of corporate issues and a history of meetings of decision-making bodies. The display area 359 of the history is an example of an area in which information indicating at least one discussion process regarding the corporate issue or the agenda item is displayed. In addition, the display area 359 of the history may include, for each meeting, a conclusion of decision making by the decision-making body such as passed or rejected, or reconsidered by a responsible department, and a display of status such as approved. For example, the user P of the corporate issue management system S may operate the “status change” to register a current state regarding the agenda item.

As described above, the corporate issue management system S according to the embodiment can display information indicating agenda item information such as history information together with the corporate issue information. The agenda item information may be, for example, information regarding a plurality of agenda items included in a corporate issue. For example, there may be a corporate issue spanning over a plurality of decision-making opportunities. For example, in a case where company relocation is a corporate issue, a plurality of agenda items such as selection of a location to move, budget, tasks, and a time for announcement to the outside of the company can be included. In this regard, with the corporate issue management system S according to the embodiment, it is possible to grasp in series when and how the respective agenda items of the corporate issue spanning over the plurality of decision-making opportunities have been handled and discussed. Note that an agenda item associated with a corporate issue may be at a hierarchy lower than the corporate issue, for example, a corporate issue that needs to be handled by a decision-making body in order to achieve a superordinate corporate issue, or may be at the same hierarchy as the corporate issue.

In addition, the corporate issue detail display screen 390 may include a display of a button 357a for giving an instruction of “Propose to meeting”. As a result, the corporate issue may be registered as an agenda item that needs to be handled by the decision-making body.

In addition, the corporate issue detail display screen 390 may include a display area 391 of an attached file related to a corporate issue. In the display area 391 of the attached file, for example, links to various files generated in a discussion process included in the corporate issue may be displayed. FIG. 11 exemplifies a case where a file “Consideration on purchase of head office building.pdf” indicating content of a resolution of the board of directors as the decision-making body is attached, but files related to content other than the content of the resolution may be displayed. Attachment of a file can be registered by any method such as uploading the file by a predetermined operation or dragging and dropping the file in the display area of the attached file. Note that not only the attached file but also a related file, a website address, and the like can be registered as information that assists management of the corporate issue.

In addition, for example, in a case where a link in the display area 391 is operated, the output control unit 11b may transmit a linked file held by the storage unit 11c to the terminal device T. As a result, it is possible to appropriately manage information regarding the corporate issue. Note that a file may be stored in the system or may be stored outside the system.

In addition, the corporate issue detail display screen 390 may include a related issue display area 393 that displays a link to a related issue. The related issue display area 393 may be an area for displaying information for further displaying at least one other corporate issue related to a corporate issue that is being displayed. FIG. 11 exemplifies a case where links to other corporate issues that consider the purchase of the head office building are displayed. For example, in a case where a link in the related issue display area 393 is operated, display may be performed by making a transition to the corporate issue detail display screen 390 for the linked corporate issue.

In the corporate issue management system S according to the present embodiment, the issue detail registration screen may be displayed in order to register or update details of a corporate issue. In addition, the corporate issue list display screen 310 in FIG. 9 may include a button 315 for giving an instruction of “Add issue” in order to newly register an issue. Similarly, the progress display screen 370 in FIG. 10 may include the display of the button 332 for giving the instruction of “Add issue” in order to newly register an issue. For example, in a case where the button 315 or the button 332 is operated, the output control unit 11b may cause the terminal device T to display the issue detail registration screen. The user P inputs an issue title which is a title of a corporate issue to register the corporate issue. The title of the corporate issue is an example of information indicating the corporate issue.

For example, in a case where the input operation by the user P to an input field on the corporate issue registration screen is received in the terminal device T, the registration management unit 11a may newly generate corporate issue information regarding the corporate issue of the input title and stores the corporate issue information in the storage unit 119. As a result, the user P can register any corporate issue in the corporate issue management system.

In addition, the output control unit 11b can display, for example, a list of pieces of information indicating a plurality of registered corporate issues including the newly registered corporate issue. As a result, the user P can register a desired corporate issue while referring to other registered corporate issues.

The issue detail registration screen may include, for example, an input area of an overview of corporate issue information, an input area of detailed information, and an input area of a proposal.

The input area of the overview of the corporate issue information may include, for example, displays of an input field for a responsible department, an input field for status, an input field for an importance level, an input field for a category, and an input field for a person in charge regarding a corporate issue to be registered or updated. As for the input, the corporate issue information may be input by being selected from a pull-down list prepared in advance, and the input may be performed in each of the input fields in advance without being limited thereto. The input may be performed by another selection method, or text input may be receivable. The user P of the corporate issue management system S according to the embodiment may register, for example, a corporate issue and at least one decision-making body that makes a decision on the corporate issue. In addition, the user P of the corporate issue management system S can register the progress regarding the corporate issue as the status. In addition, a conclusion of decision making and decided matters can be registered in text or the like.

In the input area of the detailed information, for example, detailed information such as the background of a corporate issue and considered content may be displayed. This may be displayed in the display area 352 of the detailed information.

The input area of the proposal may be, for example, an area for inputting agenda item information regarding at least one agenda item on the corporate issue for which decision-making is performed by the decision-making body. For example, the registration management unit 11a may receive input of a title (proposal title) of the proposed agenda item, the decision-making body of the agenda item, content of a proposal, a proposal time, and a message to a bureau.

In addition, the corporate issue registration screen may include the display of the button 357a for giving the instruction of “Proposal to meeting”, similarly to the corporate issue detail display screen 390. For example, the registration management unit 11a may receive a proposal to a meeting for an agenda item according to a user operation, and register the proposal in association with a corporate issue. In addition, in a case where the button 357a is operated, that is, in a case where the proposal to the meeting for the agenda item is received, the registration management unit 11a may generate notification information for notifying the user PK of a bureau in a decision-making body for the agenda item that the agenda item has been proposed.

Note that a format describing content and the like required to be described in a proposal may be displayed in the issue detail registration screen or an input field. As a result, an agenda item can be appropriately drafted and proposed, and a meeting can be smoothly operated. A plurality of types of the formats may be provided, for example, for each decision-making body, for each type of agenda item, and the like.

Note that the registration management unit 11a may include a workflow proposal function, an issue input assistance function, and a recommendation function. For example, the registration management unit 11a may propose a decision-making body or a necessary meeting to the user P in accordance with content of a corporate issue, a law that defines a meeting body, company regulations, approval request regulations, and the like. For example, the registration management unit 11a may propose, to the user P, a decision-making body or a meeting that has made a decision on another corporate issue having similar corporate issue information such as a title and a category of the corporate issue. For example, when corporate issue information such as a title and a category determined in accordance with regulations in advance is included, the registration management unit 11a may propose, to the user P, a decision-making body or a meeting determined in accordance with the regulations in advance. The input assistance function and the recommendation function may allow a user of the system to register a related internal agreement (for example, details that need to be resolved by a certain decision-making body, an upper limit of an amount of money that can be resolved, the order of deliberation in a case where the deliberation by a plurality of decision-making bodies is required, and the like) in advance.

FIG. 12 illustrates a meeting management screen 410 that displays a meeting of a decision-making body for resolving each agenda item included in a corporate issue. As illustrated in FIG. 12, the meeting management screen 410 may include, for example, a meeting list display area 413 to display a list of a plurality of meetings registered in the corporate issue management system S. The meeting list display area 413 may include, for example, displays of a meeting name, a decision-making body, the date and time, an agenda item, and an invitee.

In addition, the meeting management screen 410 may include a display of an input field 411 for input of a search keyword. For example, the output control unit 11b can narrow down meetings to be displayed in a list based on the search keyword input by the user P and a plurality of pieces of registered meeting information. As a result, the user P can easily confirm a total amount of the meetings of the decision-making bodies while maintaining the browsability, and can easily access desired meeting information such as a schedule and a result of a discussion regarding a corporate issue or an agenda item.

In addition, the meeting management screen 410 may include a display of a button 415a for giving an instruction of “Add decision-making body”. As a result, for example, a page for setting a decision-making body may be displayed, and information on at least one decision-making body that makes a decision regarding an agenda item may be added and registered based on a user input on the page.

In addition, the meeting management screen 410 may include a display of a button 415b for giving an instruction of “Add meeting”. For example, in a case where the display of the button 415b is operated, the registration management unit 11a can receive proposal of an agenda item or addition of a meeting regarding the agenda item based on a user input on the displayed screen, and can perform registration in association with a corporate issue. In addition, in a case where addition of a meeting is received, the registration management unit 11a may generate notification information for notifying the user PK of a bureau of a decision-making body that makes a resolution on the proposed agenda item at the meeting that the agenda item has been proposed. The addition of the meeting may be performed by a user operation or may be set by the system. For example, in a case where a predetermined meeting is set to be held every month, quarter, or year, the system may register information on the meeting accordingly.

In addition, the meeting management screen 410 of FIG. 12 may include a display of a button 417a for giving an instruction of “Display list” and a button 417b for giving an instruction of “Display calendar”. For example, in a case where the display of the button 417a for giving the instruction of “Display list” is operated, the output control unit 11b may cause the screen display on the terminal device T to transition from the meeting management screen 410 in FIG. 12 to a calendar display screen in which the plurality of meetings registered in the corporate issue management system S are displayed on a calendar for display. In addition, in a case where the display of the button 417a giving the instruction of “Display list” is operated on the displayed calendar display screen, for example, the output control unit 11b may switch the screen display on the terminal device T from the calendar display screen to the meeting management screen 410 in FIG. 12.

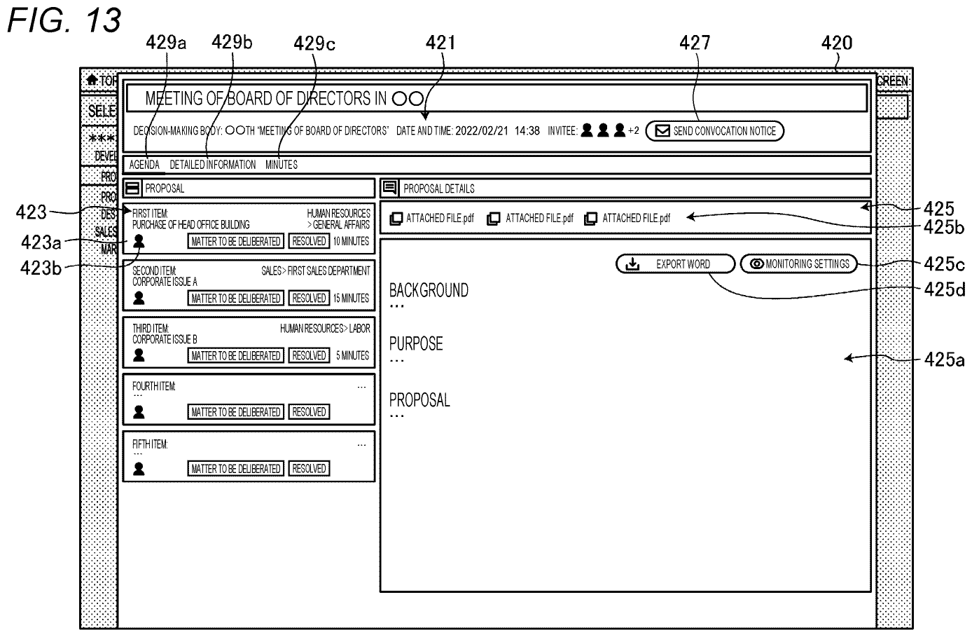

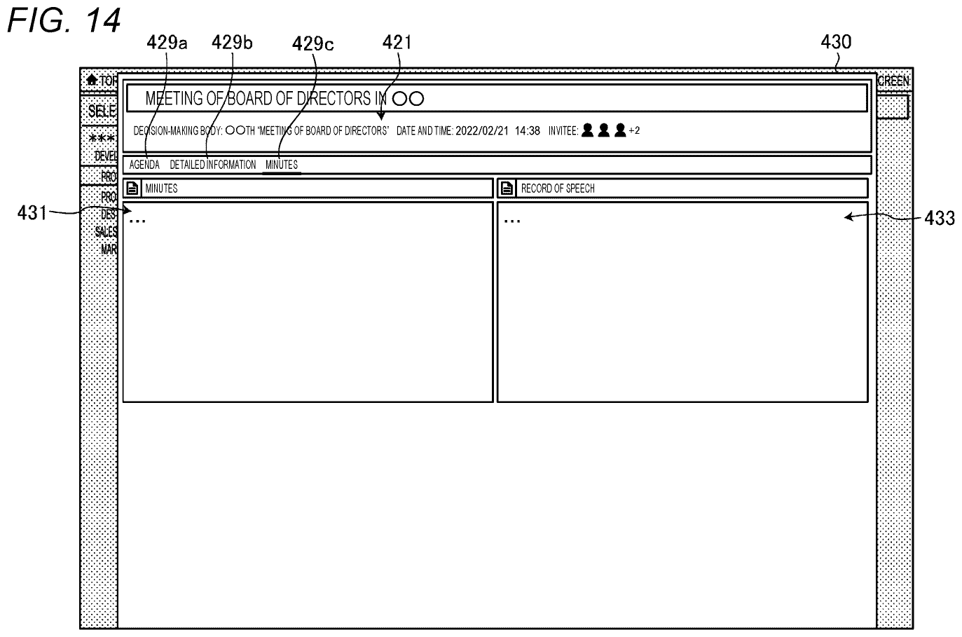

In addition, for example, in a case where a display of any meeting among the plurality of meetings is operated, the output control unit 11b may cause the terminal device T to display a meeting detail display screen 420 in FIG. 13 or a minute display screen 430 in FIG. 14. Here, the description will be continued by exemplifying a case where a display of a meeting 413a with a title “Meeting of board of directors in this month” is operated on the meeting management screen 410 in FIG. 12.

FIG. 13 illustrates the meeting detail display screen 420 that displays an agenda item of a meeting. For example, as illustrated in FIG. 13, the meeting detail display screen 420 may include a display area 421 of meeting information, a display area 423 of a proposal, and a display area 425 of proposal details.

As an example, the display area 421 of the meeting information may be an area for displaying overview information of the meeting that contributes to the operation of the meeting. The display area 421 of the meeting information may include, for example, displays of a decision-making body, date and time, and an invitee as the meeting information.

The display area 423 of the proposal may display, for example, a list of at least one agenda item proposed for the meeting that is being displayed. The display of each agenda item may include, for example, displays of an overview of the agenda item, a proposal title of the agenda item, a proposer of an item, a responsible department, status, and an estimated time required for proposal and discussion of the agenda item. As a display 423b of the proposer of the proposal, for example, a name of the proposer (drafter) of the item, an icon representing the drafter, or the like may be displayed. In a case where a display of any agenda item among a plurality of agenda items displayed in a list in the proposal display area 423 is operated, the output control unit 11b may change, for example, a display of the display area 425 of the proposal details on the meeting detail display screen 420 of FIG. 13 to a display for the operated agenda item. Here, a case where a display of an agenda item 423a with a proposal title “First item: purchase of head office building” is operated on the meeting detail display screen 420 of FIG. 13 will be described as an example.

A user who sets the meeting can set and operate the meeting based on the estimated time of each agenda item. In addition, an agenda item of the meeting may be selected based on a priority level according to the setting of the meeting such as an urgency level, an importance level, or the like set in the agenda item. In addition, the system can propose agenda items that can be discussed at the meeting based on the estimated time of each of the agenda items and the time set for the meeting. If a total estimated time for the agenda items exceeds the time set for the meeting, the system can display this for the user. The estimated time of the agenda item can be modified, such as shortened or extended, if necessary.

In addition, it is possible to automatically propose an agenda item to a meeting or recommend the proposal based on a time set to handle the agenda item. For example, by registering an agenda item that is set to be regularly deliberated and reported or to be reported next time, or an agenda item to be handled by a predetermined decision-making body at the end of every year, it is possible to automatically propose the agenda item to a meeting at an appropriate time.

The display area 425 of the proposal details may include, for example, displays of agenda item content 425a, a button 425b of an attached file, a button 425d for instructing output of the agenda item to any file, and a button 425c for instructing monitoring settings. The display of the agenda item content 425a may display, for example, detailed information of the agenda item such as the background, the purpose, and the content of the proposal. Examples of the button 425b of the attached file are links to various files uploaded to the corporate issue management system S and held by the storage unit 11c when the agenda item has been proposed. For example, in a case where the button 425b of the attached file is operated, the output control unit 11b may transmit a linked file held by the storage unit 11c to the terminal device T. For example, in a case where the button 425d for instructing writing of the agenda item content is operated, the output control unit 11b may generate a file including the agenda item content 425a that is being displayed and transmits the file to the terminal device T. For example, in a case where the button 425c for instructing the monitoring settings is operated, the registration management unit 11a may register a conclusion or content of a resolution of a discussion regarding the agenda item. As a result, it is possible to register that the agenda item is required to be monitored, that is, reported. When the report or a proposal for the agenda item as an execution result is required on a regular basis, it is possible to issue a notification for the report at an appropriate timing and to urge the proposal to a meeting. Note that the monitoring settings may be settings for notifying an update regarding a corporate issue including the agenda item or another agenda item included in the corporate issue.

In addition, the meeting detail display screen 420 may include displays of a button 429a for instructing display of “Agenda item”, a button 429b for instructing display of “Detailed information”, and a button 429c for instructing display of “Minutes”. For example, in a case where the display of the button 429c for instructing the display of “Minutes” is operated, the output control unit 11b may cause the screen display on the terminal device T to transition from the meeting detail display screen 420 in FIG. 13 to the minute display screen 430 in FIG. 14 for display.

FIG. 14 illustrates the minute display screen 430 that displays the minutes of a meeting. For example, as illustrated in FIG. 14, the minute display screen 430 may include a display area 421 of meeting information, a display area 431 of the minutes, and a display area 433 of a record of speech. Information displayed on the minute display screen may be input from a minute information input screen, may be input from an input field provided in the minute display screen, or may be input by reading another file or the like.

The display area 431 of the minutes may be, for example, an area for displaying the minutes of the meeting such as content of a resolution and a conclusion. Note that, in a case where the minutes are registered, the registration management unit 11a may generate the notification information 211 for notifying the registration of the minutes. In other words, the registration management unit 11a can implement a function of circulating the minutes. As a result, the user can easily grasp the minutes of the meeting.

The display area 433 of the record of speech may be, for example, an area for displaying a discussion process such as content of speech of members of the meeting. Note that the minutes and the record of speech may be automatically input by voice recognition, or may be generated based on voice data obtained by recording the meeting.

For example, in a case where the display of the button 429a for instructing the display of “Agenda item” is operated, the output control unit 11b may cause the screen display on the terminal device T to transition from the minute display screen 430 in FIG. 14 to the meeting detail display screen 420 in FIG. 13.

With the above corporate issue management system S, corporate issues can be appropriately managed.

Various types of information stored in the corporate issue management system S or created in relation to the corporate issue management system S may be stored or created by the user, or created using a predetermined prototype, and may be generated using a generative model.

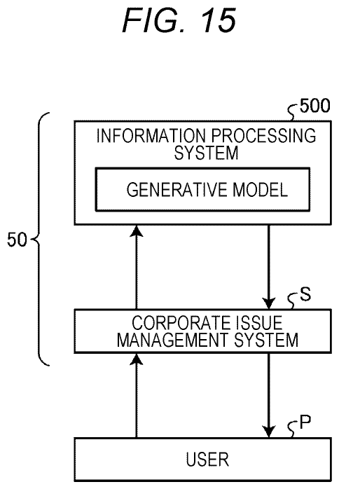

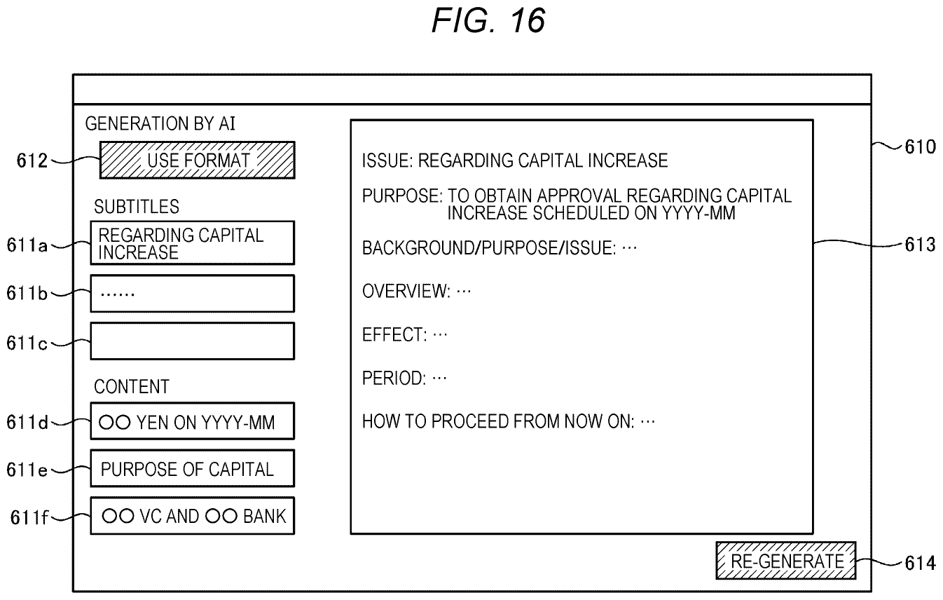

FIG. 15 is a diagram illustrating an example of an overview of a management system 50 including the corporate issue management system S according to the embodiment and an external information processing system 500. FIG. 16 is a view illustrating an example of an agenda item generation screen 610 displayed as a web browser screen on at least one of the display devices 30 of the terminal devices T in the corporate issue management processing according to the embodiment. The corporate issue management system S and the information processing system 500 may be configured as independent systems as this embodiment. The corporate issue management system S and the information processing system 500 may be configured as one system. In addition, the information processing system 500 may be one that is operated by an entity different from that of the corporate issue management system S, that is, may be an external service provided by a third party.

The information processing system 500 may be, for example, an information processing system that generates information based on a trained model, specifically, an input in a natural language called prompt data or an input sentence and a large language model. More specifically, the information processing system 500 may include, for example, a machine learning model called a large language model (LLM). Examples of the machine learning model include bidirectional encoder representations from transformers (BERT) and a generative pre-trained transformer (GPT), particularly ChatGPT or GPT-4. The information processing system 500 can implement functions thereof by using a hardware configuration, for example, a storage area, similar to that of the corporate issue management system S or by causing a processor to execute a program stored in the storage area.

As an example, the information processing system 500 may have a configuration similar to that of a general computer similarly to the corporate issue management server 10 of the corporate issue management system S described with reference to FIG. 2, for example, and include a processor, a main storage device (memory), an auxiliary storage device (memory), a network interface, and a device interface as an example. The processor, the main storage device, the auxiliary storage device, the network interface, and the device interface of the information processing system 500 may have hardware configurations similar to those of the processor 11, the main storage device 13, the auxiliary storage device 15, the network interface 17, and the device interface 18 of the corporate issue management server 10, respectively, and the description thereof will be omitted. Note that the device interface in the information processing system 500 is not an essential configuration, and can be omitted as appropriate.

The generative model (for example, parameters defining the model) may be stored in a memory in the corporate issue management system S, or may be stored in a memory in the external information processing system 500 connected to be capable of communicating with the corporate issue management system S as illustrated in FIG. 15. When the generative model stored in the external information processing system 500 is used, the user can use a high-performance generative model while reducing the burden of cost such as training and maintenance of the model. In addition, the generative model may include a first generative model and a second generative model. When a plurality of models are used, for example, when the first generative model is used as a general-purpose large language model that does not use user information provided by an external vendor for training and the second generative model is trained or tuned according to preference or tendency based on the user information, it is possible to generate more appropriate information for the user and to more appropriately manage corporate issues. Note that the second generative model in this case may generate information to be an input of the first generative model or adjust an input and an output of the first generative model.

The first generative model may be stored in the external information processing system 500, and the second generative model may be stored in the same storage device (memory) or different storage devices (memories) in the corporate issue management system S connected to be capable of communicating with the external information processing system 500. Note that the second generative model may be one or more layers constituting a part of the first generative model, or may be a model separated from the first generative model.

In the corporate issue management system S, the generative model can be variously utilized.

For example, information such as a corporate issue and an agenda item registered in the corporate issue management system S may be generated using the generative model. FIG. 16 illustrates an example of an agenda item generation screen 610 as an example of information generation using the generative model. In order to appropriately generate a draft of an agenda item, the agenda item generation screen 610 may include a generative model-related information input area 611 of information to be used for generation and included in prompt data, for example, a keyword, a title, a subtitle, and an overview related to the agenda item, and a file in which such information is recorded. The generative model-related information input area 611 in FIG. 16 exemplifies a plurality of subtitles 611a, 611b, and 611c and a plurality of pieces of content (for example, overviews) 611d, 611e, and 611f. In this area, the user may input information regarding the agenda item directly or by selecting what has been proposed in a corporate issue management system. A format, input by the user or stored together, of the generative model-related information may be used. In the present embodiment, a button 612 indicating an instruction to use the format may be displayed on the screen.

Thereafter, for example, in accordance with an instruction from the user such as clicking a button (the button 612 in the present embodiment) for instructing generation, prompt data including a command statement for drafting the agenda item in accordance with the information regarding the agenda item may be generated in the corporate issue management system S and transmitted to the external information processing system 500. Then, a proposal generated by the external information processing system 500 may be received by the corporate issue management system S and displayed in a generated information display area 613 of the agenda item generation screen 610 of the user. In addition, for example, re-generation may be performed in response to an input to the generative model-related information input area 611 and a selection operation by the user. In the example of FIG. 16, the proposal for the agenda item may be generated once and displayed in the generated information display area 613, and a button 614 for instructing the re-generation is displayed.

A sentence to be generated may be, for example, the wording such as an itemized description, a phrase, or a subtitle, or the like. Note that a format defined for each meeting or each document may be prepared and input to the generative model together. For example, it is possible to draft an agenda item according to a format by using prompt data “Generate the agenda item of a management meeting including these words in accordance with the format of the agenda item of a corporate issue”. This format can be set by the user or the corporate issue management system S.

In addition, for example, the generative model can be used to generate and summarize the minutes, drafts of corporate issues and agenda items, in-house materials, and the like and to extract any information, for example, extract any information such as the main agenda item and a schedule from the minutes. In addition, for example, it is possible to generate a document (for example, some highly confidential agenda item or item may be deleted or replaced with the wording indicating that it cannot be browsed) having a different level of detail depending on browsing authority or the like regarding certain content. In addition, an overview of the agenda item and a summary of a conclusion can be generated. In addition, it is possible to integrate discussions over a plurality of meetings and items and generate the summary or abstract of circumstances. Such a summary may be displayed on the screen together with the document before being summarized, or may be displayed so as to roll over to an icon or an area indicating the agenda item on an overview display screen (for example, the generated information display area 613).

In addition, it is possible to extract a portion considered to be important or a portion desired to be noted using the generative model, and display such a point to be emphasized by highlighting or the like. For example, it is possible to extract pieces of necessary information such as background, a conclusion, confirmed matters, decided matters, pointed-out matters, actions associated with tasks, an amount of money, and a schedule from the minutes or the summary of the minutes by the large language model, and further apply highlight display in different colors or displays according to types of pieces of the information.

In addition, for example, information necessary for corporate issue management may be retrieved and output using the generative model. The output may be, for example, generation of an answer or a draft answer to a question based on information obtained by searching in-house documents (for example, business plans, financial plans, and the like, company regulations, and information on the other parties of transactions) including materials used for presentation at meetings and content and grounds related to an agenda item, the question relating to content that the user desires to confirm at the time of drafting the agenda item, or may be a draft answer to a question included in the agenda item.

In addition, for example, the generative model may be used to answer an inquiry about information related to agenda items, laws, rules, guidelines, company regulations, formats, manuals, and the like. In addition, the above may be output and displayed using, for example, prompt data for displaying information on an in-house approval request route necessary for drafting and proposing agenda items and information on laws that should be complied with or are considered to have a risk in relation to the agenda items and content of resolutions.

In the search based on the in-house documents and the answer output, for example, first, prompt data including a command to output an appropriate search query (for example, a keyword, SQL, or the like) for obtaining information to answer the user's question or inquiry may be generated for the large language model. Then, the prompt data may be input to the large language model, and the obtained search query may be used to search the Internet, the corporate issue management system, a database owned by the user, and the like. After a document including information necessary for an answer to the question is specified by the search, information in the document and an instruction statement may be input to the large language model or a proofreading program such that the information has an appropriate answer form, and the answer to the user's question or inquiry can be obtained as the output. The proofreading program may be appropriately stored in an internal memory of the corporate issue management system S or the information processing system 500 if necessary.

Note that it is preferable to prepare prompt data for a typical question or inquiry as a template. As a result, the user does not need to input the entire text of the prompt data. Examples of an inquiry include drafting, investigation, summarization, proofreading, and display of related rules. When prompt data including a command statement that can execute an inquiry is created in advance in association with a button or a drop-down menu with content of the inquiry, the user can easily make the inquiry by performing selection or the like.

As for the input and output of the generative model, the user may perform the input into a window and the output may be displayed in the window, or an interactive type, such as a chatbot, may be adopted.

The corporate issue management system S may be capable of performing management, such as display and monitoring, of tasks other than tasks, set as agenda items of management and meetings, similarly to the agenda items and the like. For example, progress confirmation and monitoring may also be performed on tasks which have been broken down in order to implement matters resolved by meetings but are not used as agenda items of the meetings to be managed by the corporate issue management system S.

The corporate issue management server 10 according to the embodiment may include at least one processor 11. The processor 11 may achieve the registration management unit 11a, the output control unit 11b, and the storage unit 11c. The processor 11 may generate display information for displaying a plurality of pieces of registered corporate issue information based on the corporate issue information including a corporate issue of an organization and information on at least one decision-making body, which makes a decision regarding the corporate issue, of the organization.

The corporate issue management method according to the present embodiment may include a step of generating display information for displaying pieces of information indicating a plurality of corporate issues included in a plurality of pieces of registered corporate issue information based on the corporate issue information including the corporate issue of an organization and information on at least one decision-making body, which makes a decision regarding the corporate issue, of the organization.

The corporate issue management program according to the present embodiment may cause a computer to generate display information for displaying pieces of information indicating a plurality of corporate issues included in a plurality of pieces of registered corporate issue information based on the corporate issue information including the corporate issue of an organization and information on at least one decision-making body, which makes a decision regarding the corporate issue, of the organization.

For example, in operation and management of an organization, various corporate issues may be set, and a decision-making body of the organization may make a decision on the corporate issues. Examples of the corporate issues include matters to be considered on the subordinate side in a layered organization system, the matters requiring decision making and sharing by the superordinate side. However, there is a problem that corporate issues may not be seen from the subordinate side, and countermeasures on the subordinate side may not be visualized from the superordinate side. In addition, there is a problem that management may not be fully completed even if corporate issues are set.

In addition, since deliberation and resolution of a corporate issue are escalated from a layer on the subordinate side to a layer on the superordinate side in the order of a division managers' meeting, a business division meeting, a management meeting, and a meeting of the board of directors from members such as the user P1, there may be a case where it is difficult to grasp the current status regarding the corporate issue because agenda items do not appropriately move to the layer on the superordinate side, it may take time to move between the layers, and it is not possible to defy the escalation. In addition, it is sometimes difficult to transmit decided matters from the superordinate side to the subordinate side.

In addition, for example, in a stage where a resolution has been made by a decision-making body to construct a new factory and increase production, and then the content of the resolution is being implemented, it is difficult for the decision-making body side to grasp information from the layer on the subordinate side such as whether an achievement has been obtained or the progress is favorable after the resolution differently from a decision-making stage, and there is a case where monitoring has not been performed.

That is, for some corporate issues, it may be difficult to grasp a similar past corporate issue, to grasp current status of decision making and information sharing of the corporate issue, to manage monitoring of future status of the corporate issue, and to share information regarding the corporate issue.

In this regard, with a technique according to the embodiment, unitary management of corporate issues can be performed by displaying pieces of information indicating the plurality of registered corporate issues. In addition, the user can easily grasp a series of flows such as which issue should be prioritized, which issue is urgent, status such as a return state, rejected, or resolved, and any transition (resolution) in each meeting body in the past. Therefore, with the technique according to the embodiment, it is possible to support corporate issue management in the organization.

The user may have different access rights to the system. The access right may be provided for each individual, or may be set for each group such as a department, a decision-making body, or a bureau to which the user belongs. In addition, the access right may be set based on information of a responsible department or the like set in a corporate issue. For example, it is conceivable that a user who is a section chief has authority to browse, write, and edit all pieces of data related to a section chiefs' meeting to which the user belongs, has no access right to data related to management meetings, and cannot browse the data, but has authority to browse and comment on data of a management meeting related to a corporate issue for which a department to which the user belongs is set as a responsible department. In addition, the access right may be set for each corporate issue. In addition, in the case of a written resolution, the setting of resolution of the user may be invalidated when the user is a related party and does not have the authority to resolve.

For example, the system can display information necessary for the corporate issue management in order to set a decision-making body corresponding to an agenda item. For example, information such as laws, rules, guidelines, company regulations, and manuals to be considered for selecting a decision-making body may be displayed. As a result, it is possible to easily perform the corporate issue management.

Note that “determining whether it is A” in the above-described embodiment may be “determining that it is A”, “determining that it is not A”, or “determining whether or not it is A”.

Note that the program executed by each device of the corporate issue management system S of the present embodiment may be provided by being recorded in a computer-readable recording medium such as a CD-ROM, a flexible disk (FD), a CD-R, and a digital versatile disk (DVD) as a file in an installable format or an executable format. In addition, the program may be provided by being incorporated in a ROM or the like in advance.

Furthermore, the program may be stored on a computer connected to a network such as the Internet and provided by being downloaded via the network. In addition, the program may be provided or distributed via a network such as the Internet.

According to at least one embodiment described above, it is possible to support corporate issue management in an organization.

Although the embodiment and modifications of the present invention have been described, the embodiment and modifications are presented as examples, and are not intended to limit the scope of the invention. The novel embodiment and modifications can be implemented in various other forms, and various omissions, substitutions, and changes can be made without departing from the gist of the invention. The embodiment and the modifications thereof are included in the scope and gist of the invention, and are included in the invention described in the claims and the equivalent scope thereof.

### Supplementary Note

(1)

A corporate issue management server including at least one processor,
wherein the processor generates display information for displaying pieces of information indicating a plurality of corporate issues included in a plurality of pieces of registered corporate issue information based on the corporate issue information including the corporate issue of an organization and information on at least one decision-making body, which makes a decision regarding the corporate issue, of the organization.
   (2)

The processor may register agenda item information regarding at least one agenda item related to the corporate issue in association with the corporate issue information.

(3)

The processor may cause information indicating the agenda item information to be displayed on a screen on which the display information is displayed.

(4)

The processor may cause information indicating at least one discussion process to be displayed regarding the corporate issue or the agenda item.

(5)

The processor may register at least one decision-making body that makes a decision regarding the agenda item.

(6)

The processor may receive a discussion in text regarding the agenda item.

(7)

The processor may register a conclusion of decision making regarding the corporate issue.

(8)

The display information may be information capable of displaying the corporate issues in one or more different displays.

(9)

The corporate issue information may include information for further displaying at least one other corporate issue related to the corporate issue.

(10)

The corporate issue information may include attribute information indicating an attribute of the corporate issue.

(11)

The processor may receive input of a task generated as a result of at least one discussion regarding the corporate issue or the agenda item, and register the received task.

(12)

The at least one decision-making body that makes the decision regarding the corporate issue may be a meeting body.

(13)

A corporate issue management method including a step of generating display information for displaying pieces of information indicating a plurality of corporate issues included in a plurality of pieces of registered corporate issue information based on the corporate issue information including the corporate issue of an organization and information on at least one decision-making body, which makes a decision regarding the corporate issue, of the organization.

(14)

A corporate issue management program for causing
a computer to generate display information for displaying pieces of information indicating a plurality of corporate issues included in a plurality of pieces of registered corporate issue information based on the corporate issue information including the corporate issue of an organization and information on at least one decision-making body, which makes a decision regarding the corporate issue, of the organization.
   (15)

A recording medium in which the program according to (14) is recorded, the program being executed by a computer.

What is claimed is:

1. A corporate issue management server comprising at least one processor,
wherein the processor generates display information for displaying pieces of information indicating a plurality of corporate issues included in a plurality of pieces of registered corporate issue information based on the corporate issue information including the corporate issue of an organization and information on at least one decision-making body, which makes a decision regarding the corporate issue, of the organization.

2. The corporate issue management server according to claim 1,
wherein the processor registers agenda item information regarding at least one agenda item related to the corporate issue in association with the corporate issue information.

3. The corporate issue management server according to claim 2,
wherein the processor causes information indicating the agenda item information to be displayed on a screen on which the display information is displayed.

4. The corporate issue management server according to claim 2,
wherein the processor causes information indicating at least one discussion process to be displayed regarding the corporate issue or the agenda item.

5. The corporate issue management server according to claim 2,
wherein the processor registers at least one decision-making body that makes a decision regarding the agenda item.

6. The corporate issue management server according to claim 2,
wherein the processor receives a discussion in text regarding the agenda item.

7. The corporate issue management server according to claim 1,
wherein the processor registers a conclusion of decision making regarding the corporate issue.

8. The corporate issue management server according to claim 1,
wherein the display information is information capable of displaying pieces of the corporate issues in one or more different displays.

9. The corporate issue management server according to claim 1,
wherein the corporate issue information includes information for further displaying at least one other corporate issue related to the corporate issue.

10. The corporate issue management server according to claim 1,
wherein the corporate issue information includes attribute information indicating an attribute of the corporate issue.

11. The corporate issue management server according to claim 2,
wherein the processor receives input of a task generated as a result of at least one discussion regarding the corporate issue or the agenda item, and registers the received task.

12. The corporate issue management server according to claim 1,
wherein the at least one decision-making body that makes the decision regarding the corporate issue is a meeting body.

13. A corporate issue management method comprising
a step of generating display information for displaying pieces of information indicating a plurality of corporate issues included in a plurality of pieces of registered corporate issue information based on the corporate issue information including the corporate issue of an organization and information on at least one decision-making body, which makes a decision regarding the corporate issue, of the organization.
